(19) United States
(12) Patent Application Publication
(10) Pub. No.: US 2024/0419394 A1
(43) Pub. Date: Dec. 19, 2024

(54) PARAMETER DEFINITION APPARATUS, METHOD OF DEFINING PARAMETER, AND MEDIUM

(71) Applicant: YAMAHA CORPORATION, Hamamatsu-shi (JP)

(72) Inventors: Masahiro NAKANISHI, Hamamatsu-shi (JP); Nobuaki HIMENO, Hamamatsu-shi (JP); Tsuyoshi OKAMI, Hamamatsu-shi (JP)

(21) Appl. No.: 18/742,006

(22) Filed: Jun. 13, 2024

(30) Foreign Application Priority Data
Jun. 19, 2023 (JP) 2023-099792

(51) Int. Cl. G06F 3/16; H04R 3/00

(52) U.S. Cl. CPC G06F 3/165; H04R 3/00; H04R 2499/13

(57) ABSTRACT

A parameter definition apparatus defines a parameter for audio processing of audio data by which sound effects are imparted to the audio data. The apparatus acquires from a first data processing device, which is different from a user device configured to use the audio data, at least one piece of data from among a pieces of data, including: (i) environmental data indicative of information related to an environment where the audio data is to be played, (ii) first device data indicative of information related to the user device, (iii) second device data indicative of information related to a second data processing device configured to process the audio data, and (iv) audio property data indicative of information related to the audio data. The apparatus then defines the parameter for the audio processing of the audio data based on the acquired at least one piece of data.

### CROSS REFERENCE TO RELATED APPLICATION

This Application is based on and claims priority from Japanese Patent Application No. 2023-099792 filed on Jun. 19, 2023, the entire contents of which are incorporated herein by reference.

### BACKGROUND

### Field of the Invention

This disclosure relates to processing of audio data for user devices.

A known user device, such as a smartphone, a portable audio player, and an audio device for a vehicle, processes audio data based on a user's preference or an environment in the vicinity of a user. For example, Japanese Patent Application, Laid-Open Publication No. 2020-109968, discloses that a user device disposed in the vicinity of a user accesses a cloud-stored user profile and defines processing parameters for audio data based on the user profile. Such a user device outputs sound based on the audio data processed in accordance with the processing parameters.

If time-varying data (e.g., an environment in the vicinity of the user) to be processed is acquired from a user device, unnecessary data is also acquired from the user device. The receipt of unnecessary data leads to additional processing and communication loads on the user device.

### SUMMARY

One aspect of this disclosure is to efficiently acquire information used for processing audio data.

In order to solve the above problem, a parameter definition apparatus according to one aspect of this disclosure is a parameter definition apparatus for defining a parameter for audio processing of audio data by which sound effects are imparted to the audio data. The apparatus includes at least one memory storing a program, and at least one processor. The at least one processor executes the program to: acquire from a first data processing device, which is different from a user device configured to use the audio data, at least one piece of data from among a plurality of pieces of data, including: (i) environmental data indicative of information related to an environment where the audio data is to be played; (ii) first device data indicative of information related to the user device; (iii) second device data indicative of information related to a second data processing device configured to process the audio data; and (iv) audio property data indicative of information related to the audio data; define the parameter for the audio processing of the audio data based on the acquired at least one piece of data; and transmit the defined parameter for the audio processing to the second data processing device.

A method according to another aspect of this disclosure is a method for defining a parameter for audio processing audio data by which sound effects are imparted to the audio data. The method includes: acquiring from a first data processing device, which is different from a user device configured to use the audio data, at least one piece of data from among a plurality of pieces of data, including: (i) environmental data indicative of information related to an environment where the audio data is to be played; (ii) first device data indicative of information related to the user device; (iii) second device data indicative of information related to a second data processing device configured to process the audio data; and (iv) audio property data indicative of information related to the audio data; defining the parameter for the audio processing of the audio data based on the acquired at least one piece of data; and transmitting the defined parameter for the audio processing to the second data processing device.

A non-transitory medium according to another aspect of this disclosure is a non-transitory medium storing a program executable by a computer to execute a method of defining a parameter for audio processing of audio data by which sound effects are imparted to the audio data. The method includes: acquiring from a first data processing device, which is different from a user device configured to use the audio data, at least one piece of data from among a plurality of pieces of data, including: (i) environmental data indicative of information related to an environment where the audio data is to be played; (ii) first device data indicative of information related to the user device; (iii) second device data indicative of information related to a second data processing device configured to process the audio data; and (iv) audio property data indicative of information related to the audio data; defining the parameter for the audio processing of the audio data based on the acquired at least one piece of data; and transmitting the defined parameter for the audio processing to the second data processing device.

### BRIEF DESCRIPTION OF THE DRAWINGS

FIG. 1 is a diagram illustrating a configuration of a data processing system 1 according to a first embodiment.

FIG. 2 is a diagram illustrating a classification of devices included in the data processing system 1.

FIG. 3A is a diagram illustrating correspondence between devices shown in FIG. 1 and devices shown in FIG. 2.

FIG. 3B is a diagram illustrating correspondence between the devices shown in FIG. 1 and the devices shown in FIG. 2.

FIG. 4 is a block diagram illustrating a configuration of a parameter definition server 10.

FIG. 5 is a block diagram of devices disposed in a vehicle C.

FIG. 6 is a diagram illustrating an arrangement of loudspeakers 56 in the vehicle C.

FIG. 7 is a flowchart illustrating procedures for a controller 103 of the parameter definition server 10.

FIG. 8 is a diagram illustrating correspondence between devices shown in FIG. 1 and devices shown in FIG. 2.

FIG. 9 is a block diagram illustrating a configuration of a parameter definition server 10 according to a second embodiment.

FIG. 10 is a flowchart illustrating procedures for the controller 103 of the parameter definition server 10 according to the second embodiment.

### DESCRIPTION OF THE EMBODIMENTS

### A: First Embodiment

### A-1: System Configuration

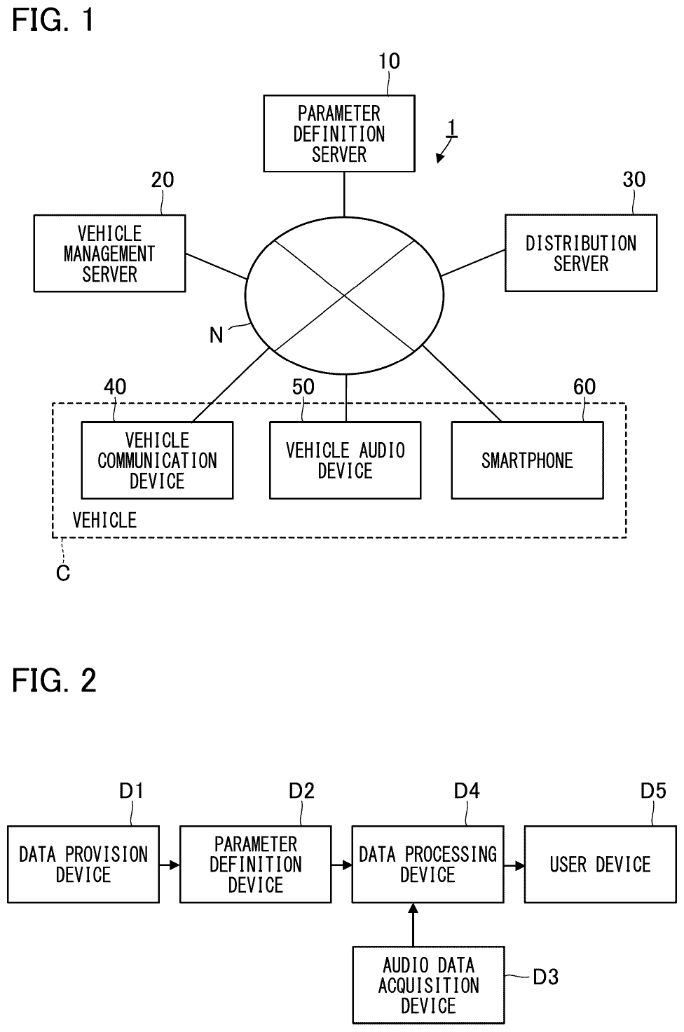

FIG. 1 is a diagram illustrating a configuration of a data processing system 1 according to a first embodiment. The data processing system 1 includes a parameter definition server 10, a vehicle management server 20, a distribution server 30, a vehicle communication device 40, a vehicle audio device 50, and a smartphone 60. The parameter definition server 10 is an example of the “parameter definition apparatus.” The vehicle communication device 40, the vehicle audio device 50, and the smartphone 60 are mounted to a vehicle C. Here, the “elements (devices) are mounted to the vehicle C” is not limited to the elements being fixed to the vehicle C, and it may also mean that the elements are brought into the vehicle C by users.

Elements, such as, the parameter definition server 10, the vehicle management server 20, the distribution server 30, the vehicle communication device 40, the vehicle audio device 50, and the smartphone 60, are each connected to a network N. The network N may be a wide area network, such as the Internet, or it may be a private network (Local Area Network) in a facility.

The parameter definition server 10 defines parameters for audio processing by which audio effects are imparted to audio data. The audio data is played back by a user device D5 (described later with reference to FIG. 2). Examples of the audio processing include environment adaptation, volume control, audio adjustment, and file format conversion. Detailed description thereof will be given later.

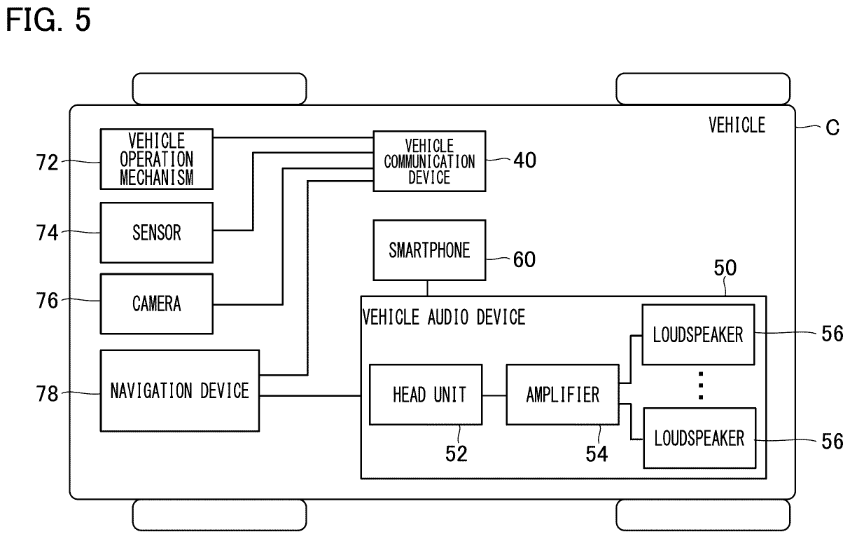

The vehicle management server 20 manages the vehicle C via the network N. In FIG. 1, one vehicle C is shown, but in practice, two or more vehicles C (vehicle communication devices 40) are managed by the vehicle management server 20 via the network N. The vehicle management server 20 acquires vehicle data from the vehicle C via the vehicle communication device 40. Examples of the vehicle data include data indicative of a running state of the vehicle C, data indicative of a vehicle operation state of the vehicle C, and detection data of a sensor 74 mounted to the vehicle C (see FIG. 5). In practice, the vehicle management server 20 also acquires vehicle data from other vehicles in addition to the vehicle C shown in FIG. 1.

The vehicle management server 20 generates control data for controlling an automatic operation of the vehicle C based on the acquired vehicle data. The vehicle management server 20 may estimate traffic congestion based on the vehicle data and distribute the traffic congestion over the network N.

The distribution server 30 distributes audio data (also referred to as “distribution audio data”) to the vehicle audio device 50 or the smartphone 60 via the network N. Examples of the distribution audio data include pieces of music, environmental sounds, talk shows, news shows, and language teaching material. The distribution server 30 not only distributes audio data, but may also distribute video data with sound. In FIG. 1, one distribution server 30 run by a distribution operating company is shown, but two or more distribution servers 30 run by different distribution operating companies may be provided.

The vehicle communication device 40 is mounted to the vehicle C and transmits vehicle data to the vehicle management server 20. The vehicle communication device 40 may be provided unitarily with the vehicle audio device 50.

The vehicle audio device 50 is mounted to the vehicle C, and includes loudspeakers 56 (see FIG. 5) that output sound to the interior of the vehicle C. Examples of sound output from the vehicle audio device 50 include pieces of music, radio sounds, spoken guidance of a navigation device 78 (see FIG. 5), and an alarm from a safety system of the vehicle C.

The smartphone 60 is a data processing terminal (computing device) and is carried by a passenger of the vehicle C. The smartphone 60 in the vehicle C may communicate with the vehicle audio device 50 by short-range radio, such as Bluetooth (registered trademark).

FIG. 2 is a diagram illustrating a classification of devices included in the data processing system 1. The devices included in the data processing system 1 are classified into five device types: a data provision device D1, a parameter definition device D2, an audio data acquisition device D3, a data processing device D4, and a user device D5.

The data provision device D1 provides the parameter definition device D2 with data used to define parameters for the audio processing. The data provision device D1 is an example of the “first data processing device that is different from the user device D5.” The parameter definition device D2 defines the parameters for the audio processing to be applied by the data processing device D4.

The audio data acquisition device D3 acquires audio data to be processed by the data processing device D4. The data processing device D4 applies audio processing to the audio data acquired from the audio data acquisition device D3 based on the parameters defined by the parameter definition device D2. The data processing device D4 is an example of the “second data processing device.” The user device D5 plays back the audio data processed by the data processing device D4.

In this embodiment, the data provision device D1 corresponds to the vehicle management server 20 or the distribution server 30. However, the data provision device D1 may correspond to both the vehicle management server 20 and the distribution server 30. The parameter definition device D2 corresponds to the parameter definition server 10. The audio data acquisition device D3 corresponds to the vehicle audio device 50 or the smartphone 60. The data processing device D4 corresponds to the parameter definition server 10, the vehicle audio device 50, or the smartphone 60. The user device D5 corresponds to the vehicle audio device 50.

In this embodiment, one device may be classified into other different categories at the same time. For example, the parameter definition server 10 may be classified as the parameter definition device D2 and the data processing device D4. The vehicle audio device 50 may be classified as the audio data acquisition device D3, the data processing device D4, and the user device D5. Such combinations are merely examples, and a variety of combinations may be adopted.

In the first embodiment, it is envisaged that the parameter definition server 10 is classified as the parameter definition device D2.

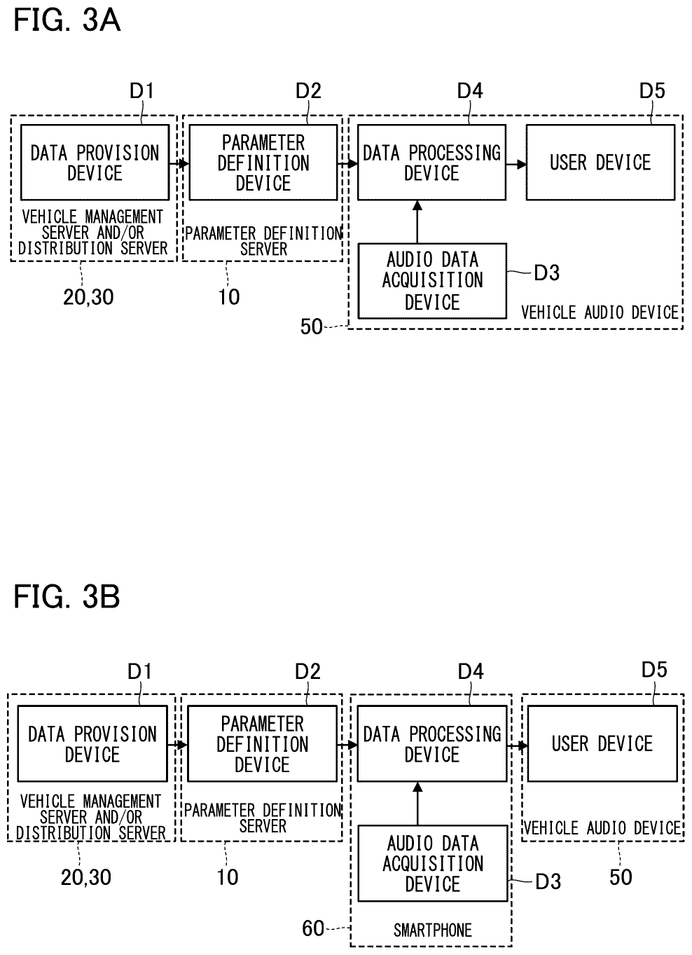

FIGS. 3A and 3B are each a diagram illustrating correspondence between the devices shown in FIG. 1 and the devices shown in FIG. 2. In the first embodiment, the devices shown in FIG. 1 are classified into the five device types shown in FIG. 3A or 3B. In the example of FIG. 3A, the data provision device D1 corresponds to at least one of the vehicle management server 20 or the distribution server 30. The parameter definition device D2 corresponds to the parameter definition server 10. The audio data acquisition device D3, the data processing device D4, and the user device D5 each correspond to the vehicle audio device 50. In the example of FIG. 3A, the data processing device D4 is the same device as the user device D5.

In the example of FIG. 3B, the data provision device D1 corresponds to at least one of the vehicle management server 20 or the distribution server 30. The parameter definition device D2 corresponds to the parameter definition server 10. The audio data acquisition device D3 and the data processing device D4 each correspond to the smartphone 60. The user device D5 corresponds to the vehicle audio device 50. In the example of FIG. 3B, the data processing device D4 is a different device from the user device D5.

As shown in FIGS. 3A and 3B, it is envisaged that the audio data acquisition device D3 is the same device as the data processing device D4. However, the parameter definition device D2 (the parameter definition server 10) may act as the audio data acquisition device D3. In this case, the parameter definition device D2 transmits to the data processing device D4, the audio data subject to the audio processing along with the parameters. Based on the parameters, the data processing device D4 applies the audio processing to the audio data received from the parameter definition device D2.

### A-2: Hardware Configuration

### A-2-1: Parameter Definition Server 10

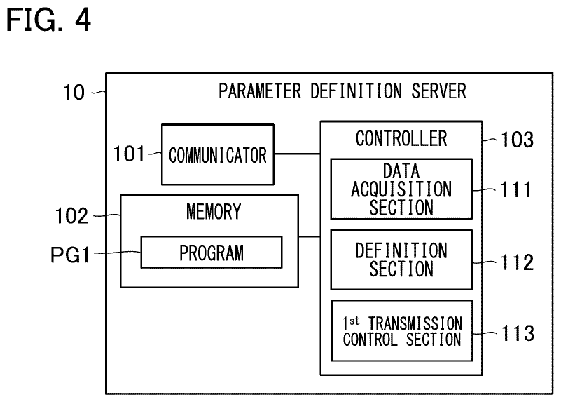

FIG. 4 is a block diagram illustrating a configuration of the parameter definition server 10. The parameter definition server 10 includes a communicator 101, a memory 102, and a controller 103. The communicator 101 communicates with other devices by wireless or wired communication. In this embodiment, the communicator 101 includes a communication interface connected to the network N by wired communication and communicates with other devices via the network N.

The memory 102 is a computer-readable non-transitory recording medium. The memory 102 includes a non-volatile memory and a volatile memory. Examples of the non-volatile memory include a ROM (Read Only Memory), an EPROM (Erasable Programmable Read Only Memory), and an EEPROM (Electrically Erasable Programmable Read Only Memory). Examples of the volatile memory include a RAM (Random Access Memory). The memory 102 may be portable and detachable to the parameter definition server 10, or it may be a cloud storage that is readable and writeable by the controller 103 via the network N. The memory 102 stores a program PG1 executed by the controller 103.

The controller 103 comprises one or more processors that control each element of the parameter definition server 10. Specifically, the controller 103 may comprise one or more processors, such as a CPU (Central Processing Unit), a SPU (Sound Processing Unit), a DSP (Digital Signal Processor), a FPGA (Field Programmable Gate Array), and an ASIC (Application Specific Integrated Circuit.

The controller 103 executes the program PG1 stored in the memory 102 and acts as a data acquisition section 111, a definition section 112, and a first transmission control section 113. Detailed description of these sections will be given later.

The vehicle management server 20 and the distribution server 30 each include a communicator, a memory, and a controller. These servers each execute a program stored in the memory and act as a server.

### A-2-2: Devices Disposed in the Vehicle C

FIG. 5 is a block diagram of devices disposed in the vehicle C. As described above, the vehicle C includes the vehicle communication device 40, the vehicle audio device 50, and the smartphone 60. The vehicle C further includes a vehicle operation mechanism 72, a sensor 74, a camera 76, and a navigation device 78.

The vehicle operation mechanism 72 includes a brake pedal, a gas pedal, a steering wheel, blinker switches, a hazard switch, and a windshield wiper switch. The vehicle operation mechanism 72 is provided in the vicinity of the driver's seat and is used to operate the vehicle C.

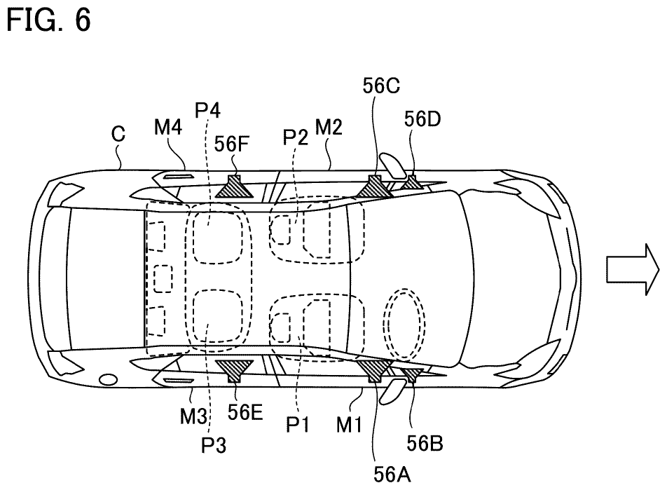

The sensor 74 detects a running state of the vehicle C, or a state of the vicinity of the vehicle C. Examples of the sensor 74 includes (i) a speed sensor and an acceleration sensor, which are used to detect a running state of the vehicle C, (ii) a thermometer and a rain-drop detection sensor, which are used to detect a state of the vicinity of the vehicle C, and (iii) seat sensors disposed at respective seats P1 to P4 of the vehicle C, which are used to detect the presence of the passengers in the seats P (see FIG. 6).

The camera 76 captures an image of the interior of the vehicle C and generates image data. The generated image data is transmitted to the vehicle management server 20 via the vehicle communication device 40. The camera 76 may capture not only the interior of the vehicle but also an exterior thereof. The camera 76 may be a dashboard camera, or it may be included in a safety system of the vehicle C.

The navigation device 78 searches for a route to a destination of the user and guides the user to the destination along the found route. Specifically, the navigation device 78 shows a map around a current location of the vehicle C, and shows a mark representative of the current location over the map. The navigation device 78 also shows a direction of the vehicle C along the route via spoken navigation. The navigation device 78 may notify the user of traffic regulations (e.g., a speed limit of the current road) via the spoken navigation. The spoken guidance of the navigation device 78 is output from the loudspeakers 56. The navigation device 78 outputs to the vehicle audio device 50, spoken guidance data (an example of the audio data) indicative of the spoken navigation. In addition, the navigation device 78 outputs to the vehicle communication device 40, position data of the vehicle C acquired by a GPS (Global Positioning System) device (not shown). The navigation device 78 includes a microphone. Audio data indicative of sound received by the microphone in the running vehicle C (ambient sound data) may be transmitted to the vehicle management server 20.

Thus, the vehicle communication device 40 transmits vehicle data to the vehicle management server 20. Examples of the vehicle data include a running state of the vehicle C, a vehicle operation state thereof, and detection data of the sensor 74.

Examples of the running state of the vehicle C include a position, a (running) speed, and an acceleration of the vehicle C. A current position is detected by the GPS device of the navigation device 78. A current speed is measured by the speed sensor (an example of the sensor 74), and a current acceleration is measured by the acceleration sensor (an example of the sensor 74).

The vehicle operation state of the vehicle C means vehicle operations made to the vehicle operation mechanism 72. Examples of the vehicle operation state include an amount of depression of the brake pedal, an amount of depression of the gas pedal, an operation amount of the steering wheel, a state of the blinker switch, a state of the hazard switch, and a state of the windshield wiper switch.

The detection data of the sensor 74 refers to data obtained by the seat sensors, the thermometer, or the rain-drop detection sensor.

A configuration of the vehicle audio device 50 will be described. The vehicle audio device 50 includes a head unit 52, an amplifier 54, and loudspeakers 56. For example, the head unit 52 is disposed on an instrument panel of the vehicle C. The head unit 52 includes a communication device, switches, an audio data reader, a memory, and a controller.

The audio data reader is used to read audio data stored in a recording medium, such as a Compact Disc and a SD card. In place of the audio data reader, a radio receiver or a television receiver may be provided. Furthermore, the audio data reader may acquire audio data from an electronic device (e.g., a portable music player) connected to the audio data reader by wireless or wired communication.

The amplifier 54 receives audio data from the head unit 52, amplifies the received audio data and supplies the amplified audio data to the loudspeakers 56. The amplifier 54 may be included in the head unit 52.

The loudspeakers 56 output sound indicated by the audio data. In this embodiment, the loudspeakers 56 comprise a loudspeaker set. An arrangement of the loudspeakers 56 differs for each vehicle type or customization of the vehicle C. The loudspeakers 56 are not limited to the loudspeaker set. A single loudspeaker may be provided in place of the loudspeakers 56.

FIG. 6 is a diagram illustrating an arrangement of the loudspeakers 56 in the vehicle C. The vehicle C is provided with a driver's seat P1, a passenger seat P2, a rear seat P3 behind the driver's seat P1, and a rear seat P4 behind the passenger seat P2.

The vehicle C includes a driver side door M1 at the driver's seat P1, a passenger side door M2 at the passenger seat P2, and passenger rear side doors M3 and M4 at the respective rear seats P3 and P4. The driver and passengers are examples of “users.”

The loudspeakers 56A and 56B are disposed at the driver side door M1 (the driver's seat P1). The loudspeakers 56C and 56D are disposed at the passenger side door M2 (the passenger seat P2). The loudspeakers 56E and 56F are disposed at the passenger rear side doors M3 and M4 (the passenger rear seats P3 and P4), respectively.

### A-3) Functional Configuration

Description will now be given of a functional configuration of the parameter definition server 10. The controller 103 of the parameter definition server 10 executes the program PG1 stored in the memory 102, to act as the data acquisition section 111, the definition section 112, and the first transmission control section 113.

The data acquisition section 111 acquires from the data provision device D1 via the network N, at least one piece of data from among the following (i) to (iv):
(i) environmental data indicative of information related to an environment in which audio data will be played back,
(ii) first device data indicative of information related to the user device D5 that uses the audio data,
(iii) second device data indicative of information related to the data processing device D4 that applies audio processing to the audio data, and
(iv) audio property data indicative of information related to the audio data.

The data provision device D1 is an example of the “first data processing device that is different from the user device D5.”

In one example, the data provision device D1 corresponds to the vehicle management server 20 that manages the vehicle C via the network N. In another example, the data provision device D1 corresponds to the distribution server 30. In this case, the user device D5 (the vehicle audio device 50) uses audio data distributed from the distribution server 30. In this embodiment, if data to be used is at least a piece of data from among the environmental data, the first device data, and the second device data, the data acquisition section 111 acquires such data from the vehicle management server 20. If the data to be used is audio property data, the data acquisition section 111 acquires the audio property data from the distribution server 30. Hereinafter, data acquired by the parameter definition server 10 (the data acquisition section 111) from the data provision device D1 is referred to as “specific data.” In other words, the specific data is at least a piece of data from among the environmental data, the first device data, the second device data, and the audio property data.

### (I) First Scenario: Automatic Transmission of Specific Data

The data provision device D1 automatically transmits the specific data to the data acquisition section 111 (the parameter definition server 10). In this scenario, for the purpose of implementing the automatic transmission of the specific data, the data acquisition section 111 (the parameter definition server 10) pre-sets to the data provision device D1, a type of the specific data to be supplied to the parameter definition server 10. In other words, the parameter definition server 10 pre-sets to the data provision device D1, which of the following is required to define parameters for audio processing at least: the environmental data, the first device data, the second device data, and the audio property data.

Alternatively, based on the occasional state, the data acquisition section 111 may cause the data provision device D1 to select a type of specific data. Examples of the occasional state include change in a numerical value (e.g., a current speed, and a current position) measured by the sensor 74. If the data provision device D1 corresponds to the vehicle management server 20, the vehicle management server 20 may supply a numerical value measured by the sensor 74 to the parameter definition server 10 in response to change in its value. The data acquisition section 111 selects the type of the specific data based on the acquired numerical value.

### (II) Second Scenario: Manual Transmission of Specific Data

The data provision device D1 transmits the specific data to the parameter definition server 10 (the data acquisition section 111) in response to a data transmission request from to the parameter definition server 10. If the data provision device D1 corresponds to the vehicle management server 20, the data acquisition section 111 transmits a data transmission request to the vehicle management server 20. The data transmission request includes a request for a first identifier and a second identifier. The first identifier is unique for the vehicle C or the vehicle audio device 50 (e.g., a model number, a manufacturer name, a manufacturer number, a registration number, etc.), and is used to identify the vehicle C or the vehicle audio device 50. The second identifier is used to identify a type of data necessary for defining parameters (a type of desired data). For example, the second identifier indicates information about at least one of the environmental data (e.g., sound of the running vehicle, a current speed, etc.), the first device data (e.g., audio features of the user device), or the second device data (e.g., performance of the data processing device). Upon receipt of the data transmission request, the vehicle management server 20 transmits to the data acquisition section 111 (the parameter definition server 10), data determined (identified) by a pair of the received first and second identifiers. The determined data serves as the specific data. For example, when the received first identifier indicates a registration number of the vehicle C, and when the received second identifier indicates a current position, the identified data indicates information on the registration number, and the current position (e.g., longitude and latitude). The vehicle or the vehicle audio device to be the subject is identified. Since a large number of vehicles are managed by the vehicle management server 20, the vehicle management server 20 transmits to the data acquisition section 111 (the parameter definition server 10), only the specific data relating to the subject vehicle.

The requested first identifier is transmitted from the user device D5 to the parameter definition server 10 at an initial setting of the user device D5 (at an initial setting of the data processing system 1). Furthermore, at the initial setting, a first server identifier is transmitted to the parameter definition server 10. The first server identifier is used to identify a vehicle management server to be the subject (i.e., the vehicle management server 20 by which the vehicle C including the user device D5 is managed). Upon a receipt of the first server identifier, the parameter definition server 10 transmits a data transmission request to the vehicle management server 20 identified by the first server identifier.

If the data provision device D1 corresponds to the distribution server 30, the data acquisition section 111 (the parameter definition server 10) transmits a data transmission request to the distribution server 30. The data transmission request includes a request for a third identifier and a fourth identifier. The third identifier is unique for a user of the distribution service (e.g., a customer number and a customer name) and is used to identify the user. The fourth identifier is used to identify a type of data necessary for defining parameters (a type of desired data). For example, the fourth identifier indicates a file format, a song name, an artist name, a musical genre, and contents to be supplied. Upon receipt of the data transmission request, the distribution server 30 transmits to the data acquisition section 111 (the parameter definition server 10), data determined (identified) by a pair of the received third and fourth identifiers. The determined data serves as the specific data. Since a large number of pieces of audio data to be distributed to users are stored by the distribution server 30, the distribution server 30 transmits to the data acquisition section 111 (the parameter definition server 10), only the specific data to be supplied to the subjected user (e.g., the user device D5).

The third identifier is transmitted from the user device D5 to the parameter definition server 10 at an initial setting of the user device D5 (at an initial setting of the data processing system 1). Furthermore, at the initial setting, a second server identifier used to identify the distribution server 30 is transmitted to the parameter definition server 10. The parameter definition server 10 transmits a data transmission request to the distribution server 30 identified by the second server identifier.

In this embodiment, the specific data is transmitted from the data provision device D1 in response to the data transmission request from the parameter definition server 10 (the data acquisition section 111).

The first identifier is transmitted from the vehicle audio device 50 to the parameter definition server 10 at the initial setting of the vehicle audio device 50. The parameter definition server 10 may identify, based on the first identifier (e.g., a model number, a manufacturer name, a manufacturer number, and a registration number), the vehicle management server 20 by which the vehicle C including the vehicle audio device 50 is managed.

Detailed description will now be given of the specific data acquired by the data acquisition section 111 (the environmental data, the first device data, the second device data, and the audio property data).

### [1] Environmental Data

The environmental data includes vehicle data. Examples of the vehicle data include a vehicle operation state of the vehicle C, and detection data of the sensor 74 of the vehicle C. The data acquisition section 111 (the parameter definition server 10) acquires the environmental data, specifically, acquires at least one of the vehicle operation state or the running state. The environmental data to be acquired may include at least one of the following (i) or (ii): (i) a vehicle interior layout (e.g., a size of the vehicle interior, a position of each seat, a position of each loudspeaker), or (ii) information on the passengers of the vehicle C (e.g., the numbers of passengers, positions of the seats, and physical characteristics).

The environmental data includes information related to ambient sound, specifically, sound in the vicinity of the vehicle audio device 50. The ambient sound includes vehicle interior sound and vehicle exterior sound. Hereinafter, the information related to ambient sound is referred to as “ambient sound data.” Examples of the vehicle interior sound include conversations of the passengers, conversations over the smartphone 60, and electronic sounds of the smartphone 60. Examples of the vehicle exterior sound include running vehicle sound, sound from other vehicles, and environmental sounds (e.g., rain noise, wind noise, spoken guidance of pedestrian signals).

The ambient sound data is generated by the navigation device 78 based on sound received by the microphone. The ambient sound data may be generated based on at least one of the following: a current location, or a current speed of the vehicle C, or an image of the exterior of the vehicle captured by the camera 76. The ambient sound data is used to estimate ambient sound.

### [2] The First Device Data

The first device data indicates audio features of the user device D5. Data indicated by the audio features is referred to as “audio feature data.” The audio features indicate how sound played back by the user device D5 is heard by the user. As described above, in the embodiment, the user device D5 corresponds to the vehicle audio device 50. The audio features of the vehicle audio device 50 include performance of the vehicle audio device 50, and information related to the vehicle interior (an acoustic space inside the vehicle).

The audio features of the vehicle audio device 50 are measured as follows. Sound for testing is output from the loudspeakers 56. For example, the sound for testing is received by external microphones disposed at the respective seats P1 to P4. Sound data generated by the microphones is output to the vehicle audio device 50. The sound for testing may be received by microphones of the head unit 52 in place of the external microphones. The sound data is transmitted from the vehicle audio device 50 to the vehicle management server 20. The vehicle management server 20 analyzes the sound data to estimate audio features of the vehicle audio device 50. The audio features based on the sound data may be estimated by the vehicle audio device 50, and a result of the estimation may be transmitted to the vehicle management server 20.

For example, audio features of the vehicle audio device 50 are measured before use of the vehicle audio device 50. Output of the sound for testing and transmission of sound data are carried out at a timing of attachment of the vehicle audio device 50 to the vehicle C, or at a first use of the vehicle audio device 50. The vehicle management server 20 estimates audio features of the vehicle audio device 50 based on the sound data. The vehicle management server 20 then records the estimated audio features in an audio feature database (not shown). Specifically, the vehicle management server 20 writes in the audio feature database, the audio features associated with an identifier (e.g., a first identifier) for identifying the vehicle audio device 50. Thus, the audio feature database includes an identifier of the vehicle audio device 50, and the audio features associated with the identifier.

The audio feature database further includes other audio features of other vehicle audio devices 50. For use of audio features of a specific vehicle audio device 50, the vehicle management server 20 may search the audio feature database, using the identifier of the specific vehicle audio device 50 as a key.

The audio features may be measured at every use of the vehicle audio device 50. In this case, output and receipt of sound for testing are carried out for each time before a start of running of the vehicle C. By such measurement of audio features, it is possible to estimate the audio features in which the environment of the interior of the vehicle is reflected for each use of the vehicle audio device 50. Even if the number of passengers and their positions in the vehicle C may vary from time to time, such measurement of audio features takes in effects of absorption and reflection of sound by the passengers.

In place of sound for testing, the vehicle management server 20 may use, as the audio features of the vehicle audio device 50, at least one of the following (i), (ii) or (iii): (i) the performances of the vehicle audio device 50, (ii) the specifications of the vehicle C, or (iii) information on the passengers of the vehicle C. The information (i), (ii) and (iii) is used to estimate the performance of the vehicle audio device 50 by a numerical simulation implemented by the definition section 112.

For example, the performance of the vehicle audio device 50 indicates product numbers (model numbers) of the head unit 52, the loudspeakers 56 and the amplifier 54. For example, the specification of the vehicle C indicates a vehicle type or a vehicle interior layout. Examples of the vehicle type include a model number and a grade of the vehicle C including the vehicle audio device 50. In general, if the vehicle type (e.g., model number and grade) is known, the vehicle interior layout and material of the seats P are identified. However, recently, if new loudspeakers 56 are mounted, it is preferable to use information on the actual vehicle interior layout (e.g., a size of the vehicle interior, positions of the seats P, and positions of the loudspeakers 56). The information on the passengers in the vehicle C refers to the number of passengers, positions of the passengers (the seats P), and their physical characteristics.

### [3] Second Device Data

The second device data indicates the performance of the data processing device D4. Specifically, the second device data relates to item numbers (model numbers) of electronic parts (e.g., a processor and a memory) mounted to the data processing device D4. In general, high-load processing on audio data leads to high quality sound. However, if the data processing device D4 has low capacity for data processing, high-load data processing would result in delays. Use of the performance of the data processing device D4 gives the data processing device D4 appropriate load.

### [4] Audio Property Data

The audio property data includes at least one of a file format of audio data, or contents thereof. The audio data content indicates at least one of a song name, an artist name, and a musical genre of the audio data.

### [4-1] File Format of Audio Data

Examples of file formats of audio data include MP3 (MPEG-1 Audio Layer-3; lossy compression), AAC (Advanced Audio Coding; lossy compression), FLAC (Free Lossless Audio Codec; lossy compression), and WAV-PCM (Waveform formatting of uncompressed PCM data). A file format of audio data is required if the file format used for the vehicle audio device 50 is defined, or if the file format differs for each distribution service by the distribution server 30.

### [4-2] Contents of Audio Data, Such as Song Name, Artist Name, and Music Genre of Audio Data

If audio data represents a piece of music, information on a song name, an artist name, and a musical genre is added to the audio data as metadata. The data acquisition section 111 (the parameter definition server 10) acquires from the distribution server 30, meta data of audio data to be output to the user device D5. In other words, the data acquisition section 111 acquires a genre of the audio data (i.e., audio property data).

The definition section 112 (the parameter definition server 10) defines parameters for audio processing based on at least one of the following: the environmental data, the first device data, the second device data, or the audio property data. In this embodiment, examples will be given of the following: audio adjustment, environment adaptation, volume control, and file format conversion.

### [A] Audio Adjustment

The audio adjustment is used to improve quality of sound to be played back by the vehicle audio device 50. The size of the interior of the vehicle C is limited, and distances between a passenger and each loudspeaker 56 differ for each passenger. Furthermore, reflection of sound by the window shields and absorption of sound by the seats P may occur, which causes reduction in the sound quality. By the audio adjustment, sound output by the vehicle audio device 50 is adjusted so as to be optimized for a passenger at each of the seats P.

Examples of the audio adjustment include time alignment, equalization, and crossover. The time alignment is used to focus sound on the passengers of the vehicle C (especially, the driver) by varying a timing of output of sound from each loudspeaker 56. Parameters representative of the timing (parameters for the time alignment) are examples of the “parameters.” The equalization is used to adjust sound balance by increasing or lowering a gain (amplification of an input signal) for each frequency band. Parameters representative of the gain (parameters for the equalization) are examples of the “parameters.” The crossover is used to adjust an output frequency band allocated to each loudspeaker 56. Parameters representative of the output frequency bands (parameters for the crossover) are examples of the “parameters.”

For the audio adjustment, the definition section 112 (the parameter definition server 10) defines parameters based on the audio features of the vehicle audio device 50 acquired by the data acquisition section 111. If audio features to be defined are given by the measurement, the definition section 112 directly defines the parameters based on the measured audio features. Otherwise, the definition section 112 estimates the audio features of the vehicle audio device 50 by implementing a numerical simulation based on at least one of the following: (i) the performance of the vehicle audio device 50, (ii) the specifications of the vehicle C, or (iii) information on the passengers of the Vehicle C.

The parameters for the equalization are defined based on the audio property data (i.e., a song name, an artist name, or a music genre). For example, the definition section 112 (the parameter definition server 10) defines the parameters based on the music genre of the audio data. Specifically, for rock music, the definition section 112 relatively increases values of two types of parameters, a parameter representative of a high-range sound volume for electronic guitar sound, and a parameter representative of a low-range sound volume for kick and bass sound. For pop music, the definition section 112 increases a value of a parameter representative of a middle-range sound volume of vocal sound.

### [B] Environment Adaptation

The environment adaptation is used to adjust a sound volume of each loudspeaker 56 based on the ambient sound of the vehicle audio device 50. Parameters for the environment adaptation are examples of the “parameters.” For noise caused by construction in the vicinity of the vehicle C, or for a loud sound of the running vehicle C, the definition section 112 (the parameter definition server 10) increases a value of a parameter representative of the sound volume of each loudspeaker 56. For conversation of the passengers, the definition section 112 may decrease the value of the parameter. The definition section 112 may change a value of a parameter representative of a frequency of sound to be output from each loudspeaker 56 based on a sound level (frequency) of the ambient sound.

The definition section 112 (the parameter definition server 10) defines the parameters for the environment adaptation based on the ambient sound data acquired by the data acquisition section 111. If the ambient sound data indicates sound received by the microphone, the definition section 112 analyzes a type and sound volume of the ambient sound. The definition section 112 then defines the parameters based on the result of the analysis. If the ambient sound data indicates other than sound received by the microphone (e.g., a current position of the running vehicle C, a current speed thereof, and an exterior image of the vehicle), the definition section 112 estimates the type and sound volume of the ambient sound. The definition section 112 then defines the parameters based on the estimation.

The type and sound volume of the ambient sound are estimated as follows.

For a current position of the running vehicle C, the definition section 112 acquires, from map data, at least one of the following: a state of a road surface at the current position, a predicted traffic volume, or an environment in the vicinity of the vehicle C (e.g., a downtown area, a residential area, or a mountainous area). The definition section 112 may acquire a real-time traffic volume or weather information in the vicinity of the running vehicle C through the network N.

For the exterior image of the vehicle captured by the camera 76, the definition section 112 analyzes the captured image to detect at least one the following: a traffic volume in the vicinity of the running vehicle C, a current position, weather conditions, a condition of the road surface, and an environment in the vicinity of the running vehicle C. The definition section 112 may detect raindrops based on the numerical value measured by a rain-drop detection sensor. From such information, the definition section 112 estimates the type and sound volume of the ambient sound of the vehicle audio device 50.

For a current speed of the running vehicle C, the definition section 112 estimates a sound volume of the running vehicle C based on the current speed of the vehicle. In general, a sound volume of the running vehicle is estimated under the assumption that a high speed of the vehicle causes loud noise.

### [C] Volume Control

The volume control is used to control sound volumes of two or more channels when sounds of the channels are output at the same time. For example, during playback of a piece of music, the volume control is implemented for a spoken guidance of the navigation device 78 or an alarm of the safety system of the vehicle C. Parameters for the volume control are examples of the “parameters.” For example, it is envisaged that spoken guidance of the navigation device 78 and a piece of music distributed from the distribution server 30 are output from the loudspeakers 56 at the same time. In this case, during playback of the piece of music, the definition section 112 (the parameter definition server 10) decreases a value of a parameter representative of the sound volume of the piece of music.

For the volume control, outputs of the loudspeakers 56 may be controlled based on the presence of the passengers in the seats P. In this case, the data acquisition section 111 (the parameter definition server 10) acquires environmental data indicative of whether passengers are in seats P. Such environmental data may indicate an image of the vehicle interior captured by the camera 76, or it may indicate a detection result of a seat sensor (not shown) of each seat P. The definition section 112 (the parameter definition server 10) decreases to be less than normal, values of parameters representative of sound volumes of loudspeakers 56 at vacant seats P. Alternatively, the definition section 112 may set the values of the parameters to a mute level.

### [D] File Format Conversion

The file format conversion is used to convert a file format of audio data into a file format supported by the vehicle audio device 50. As described above, audio data has a variety of file formats. In some cases, depending on file formats, the audio data is not supported by the vehicle audio device 50. In general, a dedicated application is applied to the distribution service of the distribution server 30. For two or more distribution services, users install or upgrade dedicated applications for the services as appropriate. By the file format conversion, distribution audio data is available without installation of dedicated applications on the vehicle audio device 50. This eliminates a burden of installation and upgrade of a dedicated application and enables seamless use of the distribution service. Here, examples of the supported file format by the vehicle audio device 50 include MP3, AAC, FLAC, and WAV-PCM. More preferable supported file format (after the file format conversion) is a FLAC (lossless compression) or WAV-PCM (uncompressed). The file formats need light processing load on decompress and does not degrade sound quality. Parameters for the file format conversion (e.g., MP3, FLAC, and WAV-PCM) are examples of the “parameters.”

The definition section 112 (the parameter definition server 10) determines necessity of the file format conversion based on the file format of audio data (audio property data) and the file format supported by the vehicle audio device 50. Specifically, when the file format of the audio data is supported by the vehicle audio device 50, the definition section 112 determines that the file format conversion is unnecessary. Otherwise, the definition section 112 determines to convert the file format of the audio data into a file format supported by the vehicle audio device 50. That is, the definition section 112 defines two parameters, a parameter representative of necessity of the file format conversion, and a parameter representative of a supported file format when the file format conversion is necessary.

The first transmission control section 113 (the parameter definition server 10) transmits the parameters defined by the definition section 112 to the data processing device D4. As shown in FIG. 3A, if the data processing device D4 corresponds to the vehicle audio device 50, the first transmission control section 113 transmits the defined parameters to the vehicle audio device 50. The vehicle audio device 50 (classified as the audio data acquisition device D3) acquires audio data. In addition, the vehicle audio device 50 (classified as the data processing device D4) applies the audio processing to the acquired audio data based on the defined parameters. The vehicle audio device 50 (classified as the user device D5) plays back sound within the vehicle C.

As shown in FIG. 3B, if the data processing device D4 corresponds to the smartphone 60, the first transmission control section 113 (the parameter definition server 10) transmits the defined parameters to the smartphone 60. The smartphone 60 (classified as the audio data acquisition device D3) acquires audio data. In addition, the smartphone 60 (classified as the data processing device D4) applies the audio processing to the acquired audio data based on the defined parameters. The smartphone 60 transmits to the vehicle audio device 50, the audio data to which the audio processing has been applied. The vehicle audio device 50 (classified as the user device D5) outputs sound in the vehicle C via the loudspeakers 56.

### A-4: Procedures for Controller 103

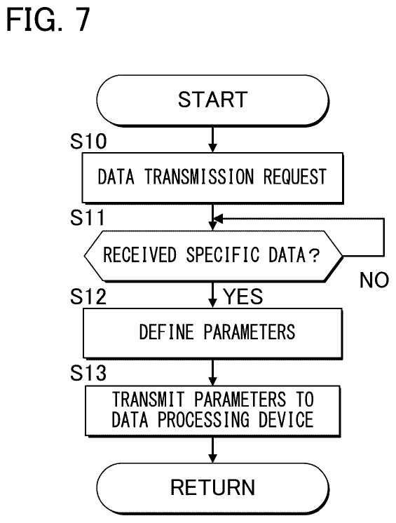

FIG. 7 is a flowchart illustrating procedures for the controller 103 of the parameter definition server 10. In the example in FIG. 7, transmission and receipt of data are implemented by file or by packet. Furthermore, the manual transmission of specific data is envisaged, in which the data provision device D1 transmits the specific data to the parameter definition server 10 in response to a data transmission request from the parameter definition server 10 (the data acquisition section 111).

The controller 103 of the parameter definition server 10 acts as the data acquisition section 111 and transmits, to the vehicle management server 20 or the distribution server 30, a data transmission request for specific data (step S10).

If the vehicle management server 20 is classified as the data provision device D1, a data transmission request includes a request for first and second identifiers and is transmitted to the vehicle management server 20. Based on the received first and second identifiers, the vehicle management server 20 selects specific data relating to the vehicle C from among the managed vehicles. The vehicle management server 20 then transmits the selected specific data to the parameter definition server 10.

Alternatively, if the distribution server 30 is classified as the data provision device D1, a data transmission request includes a request for third and fourth identifiers and is transmitted to the distribution server 30. Based on the received third and fourth identifiers, the distribution server 30 selects specific data to be supplied to the subjected user (the user device D5), from among the stored pieces of audio data to be distributed to users.

The controller 103 (the parameter definition server 10) stands by until receipt of the specific data (step S11: NO). Upon the receipt of the specific data (step S11: YES), the controller 103 acts as the definition section 112 and defines parameters for audio processing based on the received specific data (step S12). The controller 103 acts as the first transmission control section 113 and transmits the parameters defined at step S12 to the data processing device D4 (step S13). The controller 103 then returns the processing to step S10.

### A-5: Summary of the First Embodiment

In the foregoing first embodiment, the parameter definition server 10 acquires from the data provision device D1 that differs from the user device D5, specific data used to define parameters for audio processing. As compared to a case in which the parameter definition server 10 acquires such specific data from the user device D5, this embodiment reduces processing load on the user device D5. Furthermore, the type of data to be acquired by the parameter definition server 10 is pre-set to the data provision device D1. As a result, only the data necessary for defining the parameters is received (acquired) by the parameter definition server 10, and processing and communication loads are reduced. Since the parameter definition server 10 acquires such data from the data provision device D1, the parameter definition server 10 can use accurate data.

In this embodiment, the user device D5 corresponds to the vehicle audio device 50 disposed in the vehicle C. The data provision device D1 corresponds to the vehicle management server 20 that manages the vehicle C through the network N. Furthermore, the parameters for the audio processing are defined based on the environmental data indicative of the environment in vicinity of the vehicle C, or the audio feature data on the vehicle audio device 50. Unlike the inside a room of a building, quality of sound played back in the interior of the vehicle C without an appropriate acoustic environment is improved.

The parameter definition server 10 acquires from the vehicle management server 20, at least one of data indicative of a running state of the vehicle C, and data indicative of a vehicle operation state of the vehicle C. As a result, at least one of the running state and the vehicle operation state is reflected in the audio processing, and quality of sound played back in the interior of the vehicle C is further improved.

In this embodiment, the vehicle audio device 50 (classified as the user device D5) uses audio data distributed from the distribution server 30 (classified as the data provision device D1) via the network N. Since the parameter definition server 10 acquires data necessary for defining parameters from the audio source (i.e., the distribution server 30), the appropriate parameters for the audio data are defined.

The parameter definition server 10 acquires from the distribution server 30, as audio property data, a genre of the audio data or a file format thereof. As a result, the audio processing is applied to the audio data in accordance with the genre of the audio data, and quality of sound indicated by the audio data played back by the user device D5 is improved. Furthermore, since the audio data is converted into a file format supported by the user device D5, the variety of audio data available for the user device D5 is increased.

In the first embodiment, the parameter definition server 10 transmits parameters to the data processing device D4. Since the audio data is processed by the different device from the parameter definition server 10, processing load on the parameter definition server 10 is reduced.

For example, as shown in FIG. 3B, if the data processing device D4 is a different device from the user device D5, processing loads on these devices are reduced. As shown in FIG. 3A, if the data processing device D4 and the user device D5 are the same device, communication load between these devices is reduced.

### B: Second Embodiment

A second embodiment of the present disclosure will be described. Elements with functions identical to those of the first embodiment shown below are omitted as appropriate, by utilizing the symbols used in the description of the first embodiment. Since a system configuration of the second embodiment is identical to that of the first embodiment, description will be omitted.

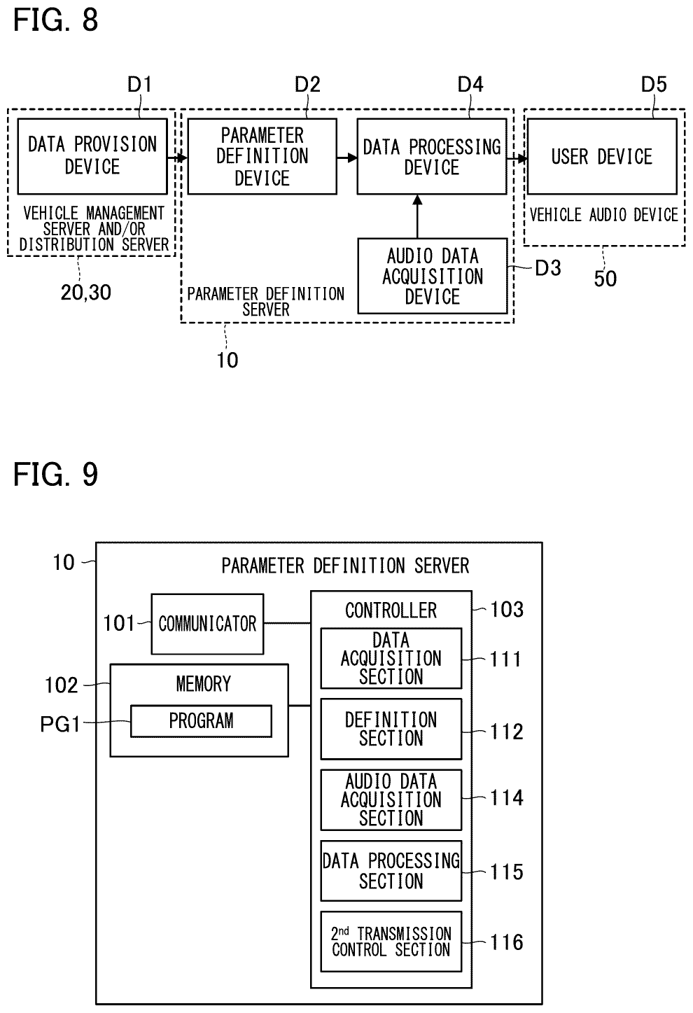

In the second embodiment, an example will now be given in which the parameter definition server 10 is classified as the parameter definition device D2 and the data processing device D4. FIG. 8 is a diagram illustrating correspondence between the devices shown in FIG. 1 and the devices shown in FIG. 2. In the example of FIG. 8, the data provision device D1 corresponds to at least one of the vehicle management server 20 and the distribution server 30. The parameter definition device D2 corresponds to the parameter definition server 10. The audio data acquisition device D3 and the data processing device D4 also correspond to the parameter definition server 10. The user device D5 corresponds to the vehicle audio device 50.

FIG. 9 is a block diagram illustrating a configuration of a parameter definition server 10 according to the second embodiment. In the second embodiment, in place of the first transmission control section 113, the controller 103 of the parameter definition server 10 acts as an audio data acquisition section 114, a data processing section 115, and a second transmission control section 116.

The audio data acquisition section 114 acquires audio data to be used by the user device D5. In one example, the audio data acquisition section 114 acquires from the distribution server 30, audio data to be distributed to the vehicle audio device 50. In another example, the audio data acquisition section 114 acquires from the vehicle audio device 50 via the network N, audio data to be played back by the vehicle C. The audio data acquired from the vehicle audio device 50 may indicate a spoken guidance of the navigation device 78, or it may be sound recorded in a Compact Disk, or it may be radio sounds.

The data processing section 115 applies audio processing to the acquired audio data based on the parameters defined by the definition section 112. Specifically, the data processing section 115 applies audio processing to the acquired audio data by at least one of the audio adjustment, the environment adaptation, the volume control, or the file format conversion, to generate processed audio data.

The second transmission control section 116 transmits the processed audio data to the vehicle audio device 50 (classified as the user device D5). The vehicle audio device 50 plays back the received audio data in the vehicle C.

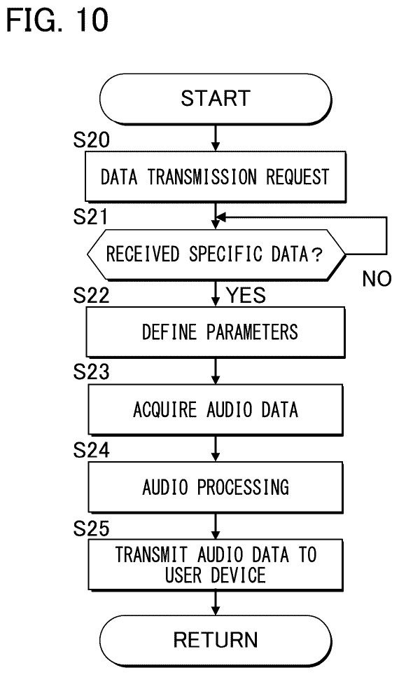

FIG. 10 is a flowchart illustrating procedures for the controller 103 of the parameter definition server 10 according to the second embodiment. In the example in FIG. 7, transmission and receipt of data are implemented by file or by packet. Steps S20 through S22 of the flowchart shown in FIG. 10 are identical to steps S10 through S12 of the flowchart shown in FIG. 7. Description thereof will be omitted.

The controller 103 acts as the audio data acquisition section 114, and acquires audio data from the distribution server 30 or the vehicle audio device 50 (step S23). The controller 103 acts as the data processing section 115. The controller 103 applies the audio processing to the acquired audio data based on the parameters defined at step S22, to generate processed audio data (step S24). The controller 103 then acts as the second transmission control section 116 and transmits the processed audio data to the vehicle audio device 50 classified as the user device D5 (step S25). The controller 103 then returns the process to step S20.

In the foregoing second embodiment, the parameter definition server 10 is classified as the parameter definition device D2. In addition, the parameter definition server 10 is classified as the audio data acquisition device D3 and the data processing device D4. Since the parameter definition server 10 applies the audio processing to the audio data, processing load on the vehicle audio device 50 or the smartphone 60 is reduced, as compared with a case in which the vehicle audio device 50 or the smartphone 60 applies the audio processing to the acquired audio data. In particular, the second embodiment is suitable for a high-load audio processing, such as processing that requires a dedicated audio processor for the vehicle audio device 50 or the smartphone 60. This is because the audio processing is implemented by the parameter definition server 10 instead of the vehicle audio device 50 or the smartphone 60. As a result, the configuration of the vehicle audio device 50 or the smartphone 60 is simplified, and cost is reduced.

### C: Modifications

Specific modifications added to each of the foregoing aspects are described below. Two or more aspects selected from the following descriptions may be combined with one another as appropriate as long as such combination does not result in any conflict.

[1] In the foregoing embodiments, description is given in which the user device D5 corresponds to the vehicle audio device 50. The user device D5 is not limited thereto, and it may correspond to an electronic device available for audio data. Specifically, the electronic device may be a smartphone 60. Examples of the electronic device include a portable audio player, a personal computer, a tablet, and a smartwatch.

[2] The functions of the parameter definition server 10 (i.e., the data acquisition section 111, the definition section 112, the first transmission control section 113, the audio data acquisition section 114, the data processing section 115, and the second transmission control section 116) are implemented by one or more processors that comprise the controller 103 and the program PG1 stored in the memory 102.

The program PG1 may be provided in a form stored on a computer-readable recording medium and be installed on a computer. For example, the recording medium may be a non-transitory recording medium. An optical recording medium, such as a CD-ROM (optical disk), is a typical example of the recording medium. Examples of the recording medium include any known recording medium, such as a solid-state recording medium and a magnetic recording medium. Examples of the non-transitory recording medium include any recording medium except a transitory and propagating signal. A volatile recording medium is not excluded. If the program PG1 is distributed by a distribution device via the network N, a recording medium storing the program in the distribution device corresponds to a non-transient recording medium.

### D: Appendixes

The following is derived from the foregoing embodiments.

A parameter definition apparatus according to one aspect (Aspect) of this disclosure is a parameter definition apparatus for defining a parameter for audio processing of audio data by which sound effects are imparted to the audio data. The apparatus includes at least one memory storing a program, and at least one processor. The at least one processor executes the program to: acquire from a first data processing device, which is different from a user device configured to use the audio data, at least one piece of data from among a plurality of pieces of data, including: (i) environmental data indicative of information related to an environment where the audio data is to be played; (ii) first device data indicative of information related to the user device; (iii) second device data indicative of information related to a second data processing device configured to process the audio data; and (iv) audio property data indicative of information related to the audio data; and define the parameter for the audio processing of the audio data based on the acquired at least one piece of data.

According to this configuration, processing load on the user device is reduced, as compared with a case in which data necessary for defining the parameter is acquired from the user device. Furthermore, the type of data to be acquired by the parameter definition apparatus is pre-set to the first data processing device, which is different from the user device. As a result, only the data necessary for defining the parameters is acquired by the parameter definition apparatus, and processing and communication loads are reduced. Since the parameter definition apparatus acquires such data from first data processing device (the different data processing device), the parameter definition apparatus can use accurate data.

In an aspect (Aspect 2) according to Aspect 1, the user device is disposed in a vehicle. The first data processing device is a vehicle management server configured to manage the vehicle via a network According to this aspect, the parameter for the audio processing is defined based on the environment in the vicinity of the vehicle or information on the user device. Unlike the inside a room of a building, quality of sound played back in an interior of the vehicle without an acoustic environment is improved.

In an aspect (Aspect 3) according to Aspect 2, the environmental data includes at least one of a vehicle operation state of the vehicle or a running state of the vehicle.

According to this aspect, at least one of the running state or the vehicle operation state is reflected in the audio processing, and quality of sound played back in the interior of the vehicle C is further improved.

In an aspect (Aspect 4) according to Aspect 1, the first data processing device is a distribution server configured to distribute the audio data via a network. The user device is configured to use the sound data distributed from the distribution server via the network.

According to this aspect, since the parameter definition apparatus acquires data necessary for defining the parameter from an audio source, the appropriate parameter for the audio data is defined.

In an aspect (Aspect 5) according to Aspect 4, the audio property data includes at least one of a genre of the audio data or a file format of the audio data.

According to this aspect, the audio data is processed in accordance with the genre of the audio data, and quality of sound played back by the user device is improved. Furthermore, since the audio data is converted into a file format supported by the user device, a variety of audio data available for the user device is increased.

In an aspect (Aspect 6) according to Aspect 1, the at least one processor executes the program to transmit the parameter for the audio processing to the second data processing device.

According to this aspect, since the audio data is processed by a different device from the parameter definition apparatus, processing load on the parameter definition apparatus is reduced.

In an aspect (Aspect 7) according to Aspect 1, the at least one processor executes the program to: acquire the audio data; process the acquired audio data based on the defined parameter for the audio processing; and transmit the processed audio data to the user device.

According to this aspect, since the audio data is processed by the parameter definition apparatus, change of the parameter is quickly reflected in the audio processing.

In an aspect (Aspect 8) according to Aspect 7, the second data processing device is also different from the user device.

According to this aspect, since the audio data is processed by the different device from the user device, the processing load of each device is reduced.

In an aspect (Aspect 9) according to Aspect 7, the user device includes the second data processing device.

According to this aspect, since the audio data is processed by the user device, communication load between these devices is reduced.

A method according to another aspect (Aspect 10) of this disclosure is a method for defining a parameter for audio processing audio data by which sound effects are imparted to the audio data. The method includes: acquiring from a first data processing device, which is different from a user device configured to use the audio data, at least one piece of data from among a plurality of pieces of data, including: (i) environmental data indicative of information related to an environment where the audio data is to be played; (ii) first device data indicative of information related to the user device; (iii) second device data indicative of information related to a second data processing device configured to process the audio data; and (iv) audio property data indicative of information related to the audio data; and defining the parameter for the audio processing of the audio data based on the acquired at least one piece of data.

A non-transitory medium according to another aspect of this disclosure is a non-transitory medium storing a program executable by a computer to execute a method of defining a parameter for audio processing of audio data by which sound effects are imparted to the audio data. The method includes: acquiring from a first data processing device, which is different from a user device configured to use the audio data, at least one piece of data from among a plurality of pieces of data, including: (i) environmental data indicative of information related to an environment where the audio data is to be played; (ii) first device data indicative of information related to the user device; (iii) second device data indicative of information related to a second data processing device configured to process the audio data; and (iv) audio property data indicative of information related to the audio data; and defining the parameter for the audio processing of the audio data based on the acquired at least one piece of data.

### DESCRIPTION OF REFERENCE SIGNS

1 . . . data processing system, 10 . . . parameter definition server, 20 . . . vehicle management server, 30 . . . distribution server, 40 . . . vehicle communication device, 50 . . . vehicle audio device, 52 . . . head unit, 54 . . . amplifier, 56 (56A to 56F) . . . loudspeaker, 60 . . . smartphone, 111 . . . data acquisition section, 112 . . . definition section, 113 . . . first transmission control section, 114 . . . audio data acquisition section, 115 . . . data processing section, 116 . . . second transmission control section, C . . . vehicle, D1 . . . data provision device, D2 . . . parameter definition device, D3 . . . audio data acquisition device, D4 . . . data processing device, D5 . . . user device, and N . . . network.

What is claimed is:

1. A parameter definition apparatus for defining a parameter for audio processing of audio data by which sound effects are imparted to the audio data, the parameter definition apparatus comprising:
at least one memory storing a program;
at least one processor that executes the program to:
acquire from a first data processing device, which is different from a user device configured to use the audio data, at least one piece of data from among a plurality of pieces of data, including:
environmental data indicative of information related to an environment where the audio data is to be played;
first device data indicative of information related to the user device;
second device data indicative of information related to a second data processing device configured to process the audio data; and
audio property data indicative of information related to the audio data;
define the parameter for the audio processing of the audio data based on the acquired at least one piece of data; and
transmit the defined parameter for the audio processing to the second data processing device.

2. The parameter definition apparatus according to claim 1, wherein:
the user device is disposed in a vehicle, and
the first data processing device is a vehicle management server configured to manage the vehicle via a network.

3. The parameter definition apparatus according to claim 2, wherein the environmental data includes at least one of a vehicle operation state of the vehicle or a running state of the vehicle.

4. The parameter definition apparatus according to claim 1, wherein:
the first data processing device is a distribution server configured to distribute the audio data via a network, and
the user device is configured to use the sound data distributed from the distribution server via the network.

5. The parameter definition apparatus according to claim 4, wherein the audio property data includes at least one of a genre of the audio data or a file format of the audio data.

6. The parameter definition apparatus according to claim 1, wherein the at least one processor executes the program to:
acquire the audio data;
process the acquired audio data based on the defined parameter for the audio processing; and
transmit the processed audio data to the user device.

7. The parameter definition apparatus according to claim 6, wherein the second data processing device is also different from the user device.

8. The parameter definition apparatus according to claim 6, wherein the user device includes the second data processing device.

9. A method of defining a parameter for audio processing of audio data by which sound effects are imparted to the audio data, the method comprising:
acquiring from a first data processing device, which is different from a user device configured to use the audio data, at least one piece of data from among a plurality of pieces of data, including:
environmental data indicative of information related to an environment where the audio data is to be played;
first device data indicative of information related to the user device;
second device data indicative of information related to a second data processing device configured to process the audio data;
audio property data indicative of information related to the audio data; and
defining the parameter for the audio processing of the audio data based on the acquired at least one piece of data; and
transmitting the defined parameter for the audio processing to the second data processing device.

10. A non-transitory medium storing a program executable by a computer to execute a method of defining a parameter for audio processing of audio data by which sound effects are imparted to the audio data, the method comprising:
acquiring from a first data processing device, which is different from a user device configured to use the audio data, at least one piece of data from among a plurality of pieces of data, including:
environmental data indicative of information related to an environment where the audio data is to be played;
first device data indicative of information related to the user device;
second device data indicative of information related to a second data processing device configured to process the audio data;
audio property data indicative of information related to the audio data; and
defining the parameter for the audio processing of the audio data based on the acquired at least one piece of data; and
transmitting the defined parameter for the audio processing to the second data processing device.
